(19) United States
(12) Patent Application Publication
(10) Pub. No.: US 2022/0343215 A1
(43) Pub. Date: Oct. 27, 2022

(54) INFORMATION PROCESSING APPARATUS, INFORMATION PROCESSING METHOD, AND COMPUTER PROGRAM PRODUCT

(71) Applicant: KABUSHIKI KAISHA TOSHIBA, Tokyo (JP)

(72) Inventors: Arika FUKUSHIMA, Kawasaki (JP); Lele XI, Inagi (JP); Hisashi YAMADA, Kawasaki (JP)

(73) Assignee: KABUSHIKI KAISHA TOSHIBA, Tokyo (JP)

(21) Appl. No.: 17/652,565

(22) Filed: Feb. 25, 2022

(30) Foreign Application Priority Data
Apr. 27, 2021 (JP) 2021-075085

(51) Int. Cl. G06N 20/00

(52) U.S. Cl. CPC G06N 20/00

(57) ABSTRACT

An information processing apparatus according to one embodiment includes one or more hardware processors coupled to a memory. The hardware processors function as an acquisition unit, a model generation unit, and a model generation unit. The acquisition unit serves to acquire one or more patterns from among multiple patterns each representing temporal variation of first data being data to be predicted. The patterns are determined for a first region designated out of regions serving as prediction targets of the first data. The model generation unit serves to generate a prediction model for predicting the temporal variation of the first data in the first region. The prediction model is generated on the basis of the acquired patterns. The model generation unit serves to determine a parameter of the prediction model.

### CROSS-REFERENCE TO RELATED APPLICATIONS

This application is based upon and claims the benefit of priority from Japanese Patent Application No. 2021-075085, filed on Apr. 27, 2021; the entire contents of which are incorporated herein by reference.

### FIELD

Embodiments described herein relate generally to an information processing apparatus, an information processing method, and a computer program product.

### BACKGROUND

There are proposed technologies for predicting future data by using a model estimated from data acquired in the past. For example, the number, density, and the like of people in a given location at a given point of time are predicted by using a model for predicting data representing a people flow (human flow) between locations.

### BRIEF DESCRIPTION OF THE DRAWINGS

FIG. 1 is a block diagram of an information processing apparatus according to a first embodiment;

FIG. 2 is a view illustrating an example of a data structure of a management table;

FIG. 3 is a view illustrating an example of a data structure of a human flow table;

FIG. 4 is a view illustrating an example of a basic pattern;

FIG. 5 is a view illustrating an example of a basic pattern;

FIG. 6 is a view illustrating an example of a basic pattern;

FIG. 7 is a view illustrating an example of a basic pattern;

FIG. 8 is a view illustrating an example of a basic pattern;

FIG. 9 is a view illustrating an example of a data structure of past data;

FIG. 10 is a flowchart of model generation processing in the first embodiment;

FIG. 11 is a view illustrating an example of a data structure of a basic pattern setting file;

FIG. 12 is a view illustrating an example of a data structure of a parameter file;

FIG. 13 is a flowchart of prediction processing in the first embodiment;

FIG. 14 is a view illustrating an example of prediction conditions;

FIG. 15 is a view illustrating an example of a data structure of a predicted value table;

FIG. 16 is a block diagram of an information processing apparatus according to a second embodiment;

FIG. 17 is a block diagram of an information processing apparatus according to a modified example of the second embodiment;

FIG. 18 is a view illustrating an example of a data structure of an air temperature table;

FIG. 19 is a block diagram of an information processing apparatus according to a third embodiment;

FIG. 20 is a flowchart of pattern generation processing in the third embodiment;

FIG. 21 is a view illustrating an example of a data structure of a similarity table;

FIG. 22 is a view illustrating an example of a display screen illustrating a relationship between a human flow model and basic patterns; and

FIG. 23 is a hardware configuration diagram of the information processing apparatus according to the first to third embodiments.

### DETAILED DESCRIPTION

An information processing apparatus according to one embodiment includes one or more hardware processors coupled to a memory. The hardware processors function as an acquisition unit, a model generation unit, and a model generation unit. The acquisition unit serves to acquire one or more patterns from among multiple patterns each representing temporal variation of first data being data to be predicted. The patterns are determined for a first region designated out of regions serving as prediction targets of the first data. The model generation unit serves to generate a prediction model for predicting the temporal variation of the first data in the first region. The prediction model is generated on the basis of the acquired patterns. The model generation unit serves to determine a parameter of the prediction model.

A description will be given below in detail of preferred embodiments of an information processing apparatus according to this invention with reference to the accompanying drawings.

An apparatus for predicting data by using a model is sometimes configured to predict data (for example, data indicating a human flow) for each of multiple sections (meshes) defined by dividing a given region. In the multiple sections, there are sections such as business districts and residential districts, which are different from one another in regional characteristics, and also there are sections having different characteristics depending on a time slot (temporal characteristics) although they are identical to one another in regional characteristics. Therefore, in use of a modeling method in which the same model is applied to all the sections, it is sometimes difficult to accurately predict data.

In the information processing apparatus according to each of the following embodiments, an appropriate model corresponding to the regional characteristics and the temporal characteristics is generated, and prediction for each of the regions (sections) is executed by using the generated model. Therefore, accuracy of the data prediction (for example, prediction of a human flow) using a model can be improved.

Note that, in each of the following embodiments, a description will be given of a case of predicting human flow data (an example of first data) indicating populations in the sections. The human flow data is, for example, populations (the number of people) or population densities. The data taken as a prediction target is not limited to the human flow data, and may be any other data such as, for example, power consumption or weather information.

### First Embodiment

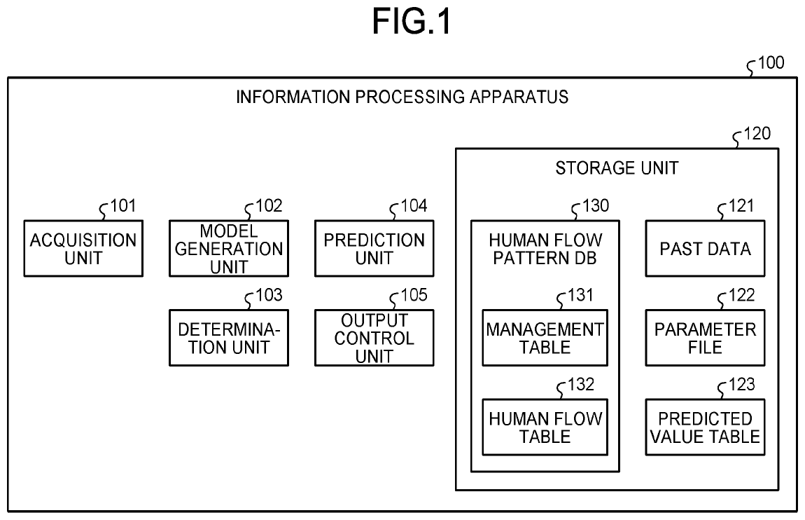

FIG. 1 is a block diagram illustrating an example of a configuration of an information processing apparatus 100 according to a first embodiment. As illustrated in FIG. 1, the information processing apparatus 100 includes an acquisition unit 101, a model generation unit 102, a determination unit 103, a prediction unit 104, an output control unit 105, and a storage unit 120.

The storage unit 120 stores a variety of data for use in a variety of processing by the information processing apparatus 100. For example, the storage unit 120 stores a human flow pattern database (DB) 130, past data 121, a parameter file 122, and a predicted value table 123. The human flow pattern DB 130 includes a management table 131, and a human flow table 132.

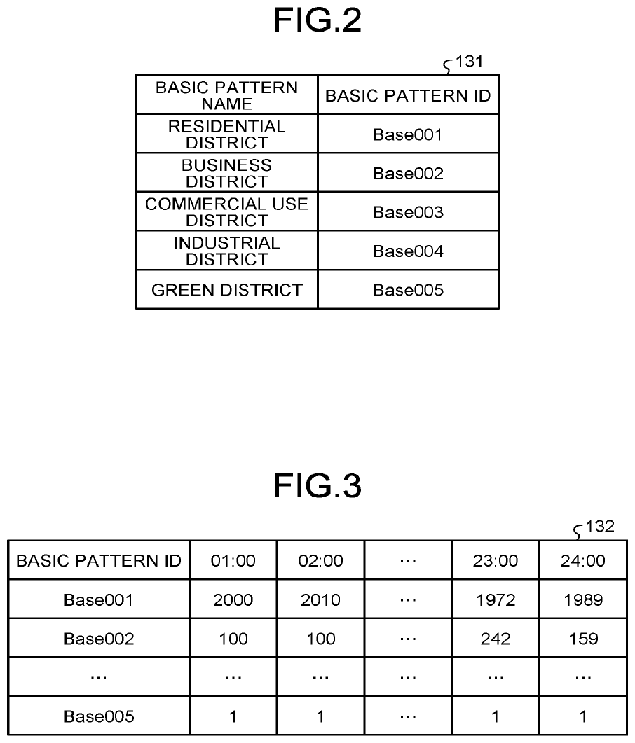

FIG. 2 is a view illustrating an example of a data structure of the management table 131. As illustrated in FIG. 2, the management table 131 includes basic pattern names that represent names of basic patterns, and basic pattern IDs. Each of the basic patterns is a pattern that represents a temporal variation of human flow data to be predicted. Each of the basic pattern IDs is identification information for identifying the basic pattern. FIG. 2 illustrates an example in which five basic patterns corresponding to regional characteristics are used.

For example, the regional characteristics are “residential district”, “business district”, “commercial use district”, “industrial district”, and “green district”. Details of the regional characteristics will be described later. Note that these regional characteristics are merely examples, and for example, the regional characteristics may be determined in accordance with “use districts” prescribed by Article 8 of City Planning Act.

FIG. 3 is a view illustrating an example of a data structure of the human flow table 132. The human flow table 132 is a table for managing predicted values of human flows in the respective time slots for each of M pieces (M is an integer of 2 or more, and is 5 (M=5) in the example of FIGS. 2 and 3) of basic pattern IDs (Base001, Base002, . . . , and Base005), which are managed by the management table 131. As illustrated in FIG. 3, the human flow table 132 describes predicted values of human flow data for each of the basic pattern IDs and for each of the time slots.

In the human flow table 132, a column name of a first column is the basic pattern ID, and column names of a second column and after are the time slots. Each time slot is described by a starting time in a format of “hh:mm”. An ending time of each time slot is immediately before a starting time described in the next time slot. Moreover, when the human flow data differs depending on an attribute of the day such as whether a day is a weekday or a holiday, the human flow data may be stored for each time slot of the week day and each time slot of the holiday. In this case, attribute distinguishing information such as “weekday_hh:mm” may be added to the column name that indicates each time slot.

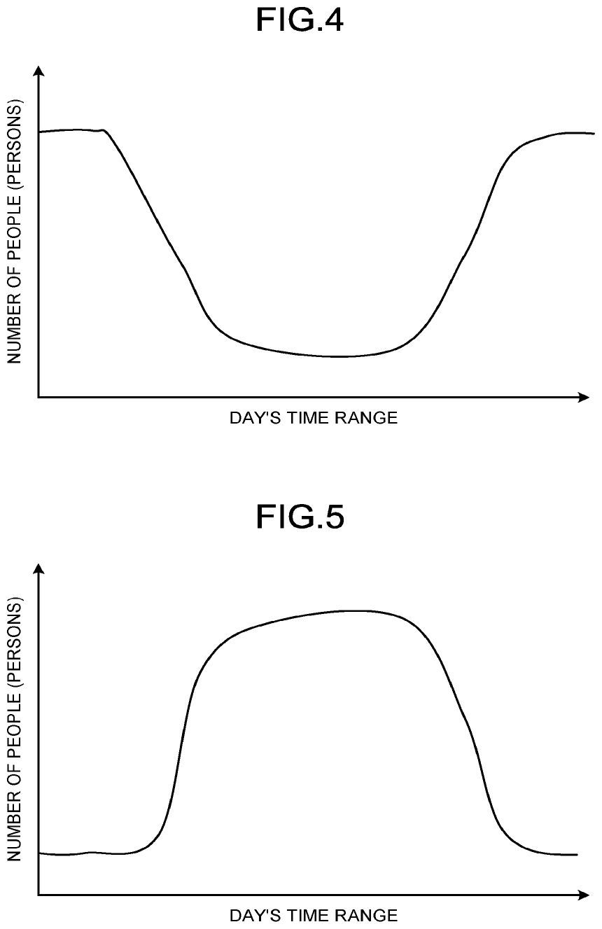

Next, a description will be given of examples of the respective basic patterns with reference to FIGS. 4 to 8. FIG. 4 is a view illustrating an example of the basic pattern that represents “residential district”. As illustrated in FIG. 4, in the residential district, the number of people (population) present in the region increases when the time slot is at midnight, and the population decreases when the time slot is in early morning. This is because, for example, people who go out to the business district increase. Since the people who went out in the early morning come back, the population increases when the time slot changes from evening to night.

FIG. 5 is a view illustrating an example of the basic pattern that represents “business district”. As illustrated in FIG. 5, on the contrary to the residential district, in the business district, the population is small when the time slot is at midnight, the population increases when the time slot is in early morning, and the population decreases when the time slot changes from evening to night.

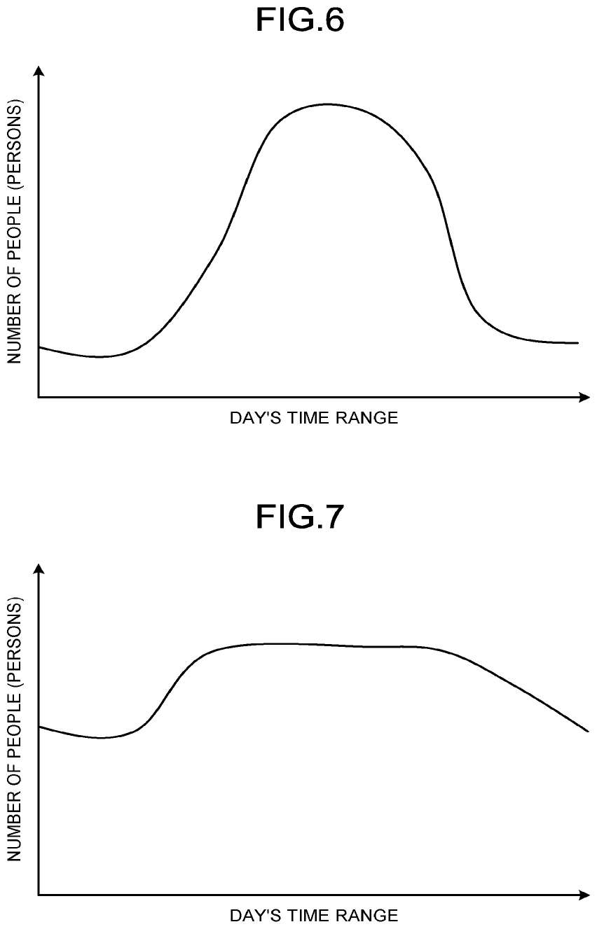

FIG. 6 is a view illustrating an example of the basic pattern that represents “commercial use district”. As illustrated in FIG. 6, in the commercial use district, the population is small when the time slot is at midnight, and the population increases before noon when commercial facilities open. Thereafter, the population reaches a peak thereof at around noon in terms of time slot, and gradually decreases toward a closing time of the commercial facilities.

FIG. 7 is a view illustrating an example of the basic pattern that represents “industrial district”. Since some factories operate at night, the population fluctuates less depending on the time slot in the industrial district than in the business district; however, it is expected that the population is larger in daytime than at night also in the industrial district as in the business district. Therefore, as illustrated in FIG. 7, in the industrial district, a tendency is maintained, in which the population increases from early morning, and the population decreases from evening to night in terms of time slot.

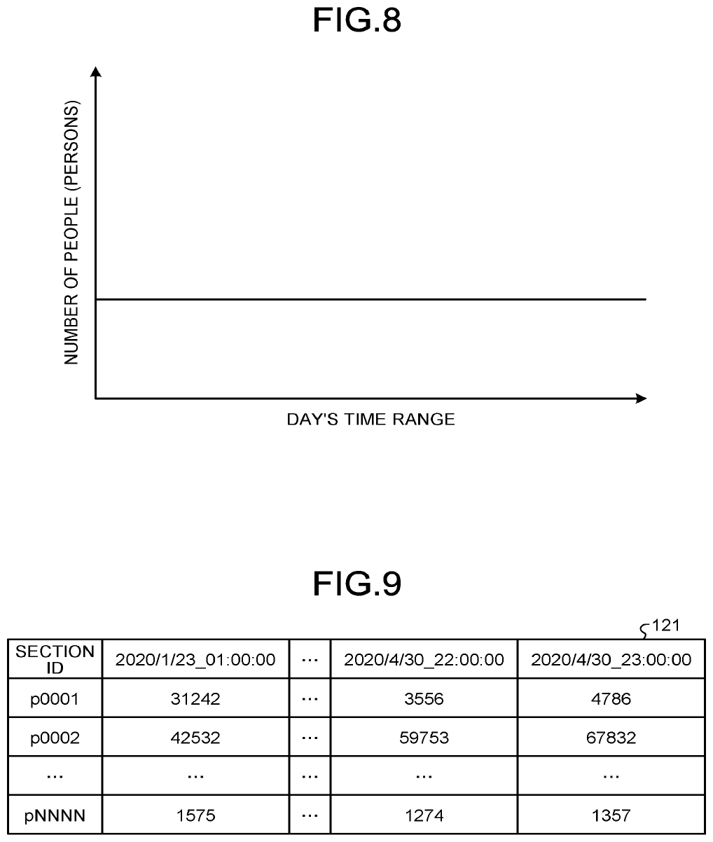

FIG. 8 is a view illustrating an example of the basic pattern that represents “green district”. As represented by forests, FIG. 8 is an example of a basic pattern of a green district that corresponds to an area which people rarely enter. As illustrated in FIG. 8, in such a case, the population is substantially constant and does not change regardless of day and night.

As will be described later, in the present embodiment, at least one basic pattern designated for each of the sections out of the basic patterns is subjected to synthesis, whereby a human flow model (an example of a prediction model) for predicting the human flow data is generated. Moreover, parameters of the human flow model are determined such that an error from measurement data (past data) being human flow data measured in the past becomes smaller.

FIG. 9 is a view illustrating an example of a data structure of the past data 121. As illustrated in FIG. 9, the past data 121 stores actual values (examples of the measurement data) of the human flow data for each of the section IDs and for each of the time slots. The section IDs are identification information for identifying the sections. In FIG. 9, “NNNN” pieces of the section IDs are described as p0001 to pNNNN. Moreover, in FIG. 9, each time slot is described by a starting time in a format of “YYYY/MM/DD_hh:mm:ss”. Each ending time of each time slot is immediately before a starting time described in the next time slot.

Note that, in FIG. 9, it is assumed that a time resolution of an equal interval (one hour), but the time slots do not need to be defined at equal intervals. In that case, the time slot may be described by such a format as “YYYY/MM/DD hh:mm:ss to YYYY/MM/DD hh:mm:ss”, that is, by a starting time and an ending time.

The storage unit 120 can be composed of every commonly used storage medium such as a flash memory, a memory card, a random access memory (RAM), a hard disk drive (HDD), and an optical disc.

The storage unit 120 may be composed of multiple storage media physically different from one another. For example, the respective data (the management table 131, the human flow table 132, the past data 121, the parameter file 122, and the predicted value table 123) may be stored in storage media different from one another. Note that details of the parameter file 122 and the predicted value table 123 will be described later.

Returning to FIG. 1, the acquisition unit 101 acquires the variety of data for use in the variety of processing by the information processing apparatus 100. For example, the acquisition unit 101 acquires information indicating a designated section (an example of a first region) out of sections, and also acquires at least one basic pattern prescribed for the designated section.

The sections may be determined in any way; however, for example, sections to be determined by such methods as follows can be used.
Regions that are partitioned to have substantially the same size on the basis of latitude and longitude are determined as the sections.
Areas that are surrounded by municipal and address boundary lines are determined as the sections.

A section for which a model is to be generated is designated by a user by using, for example, an input device (such as a keyboard, a mouse, and a touch panel; not illustrated). A method for designating the section may be any method; however, for example, a method of selecting a section from sections displayed on a display device, or the like can be applied.

The acquisition unit 101 acquires information (section ID and the like) indicating the section designated by the user as described above. Moreover, the acquisition unit 101 refers to a basic pattern setting file (details will be described later) in which the basic pattern for each of the section IDs is determined, and acquires information indicating the basic pattern determined for the designated section.

On the basis of the basic pattern acquired by the acquisition unit 101, the model generation unit 102 generates the human flow model (prediction model) for predicting a temporal variation of human flow data in the designated section. For example, the model generation unit 102 synthesizes the basic patterns, thereby generating the human flow model. Details of the model generation processing will be described later.

The determination unit 103 determines the parameters of the human flow model generated by the model generation unit 102. For example, the determination unit 103 determines the parameters of the human flow model such that an error between the past data 121 corresponding to the measured human flow data and the human flow data predicted by the human flow model becomes smaller.

By using the human flow model in which the parameters are determined by the determination unit 103, the prediction unit 104 executes prediction processing for predicting the human flow data of the designated section and time slot.

The output control unit 105 controls output processing for the variety of data by the information processing apparatus 100. A method for outputting the information by the output control unit 105 may be any method; however, there can be applied a method of displaying the information on the display device, a method of transmitting the information to an external device connected by a network, and the like.

The above-described respective units (the acquisition unit 101, the model generation unit 102, the determination unit 103, the prediction unit 104, and the output control unit 105) are achieved, for example, by one or more hardware processors. The above-described respective units may be achieved by causing a hardware processor, such as a central processing unit (CPU), to execute a computer program, that is, be achieved by software. The above-described respective units may be achieved by one or more hardware processors such as dedicated integrated circuits (ICs), that is, be achieved by hardware. The above-described respective units may be achieved by using software and hardware in combination. When multiple processors are used, each of the processors may achieve one of the respective units, or may achieve two or more of the respective units.

Note that, in FIG. 1, the information processing apparatus 100 includes both of a function to generate the human flow model (a generation function) and a function to perform the prediction by using the generated human flow model (a prediction function). Alternatively, the information processing apparatus 100 may be configured to include only one of these functions. For example, the information processing apparatus 100 may also be configured not to include the prediction unit 104 in the case of including the generation function.

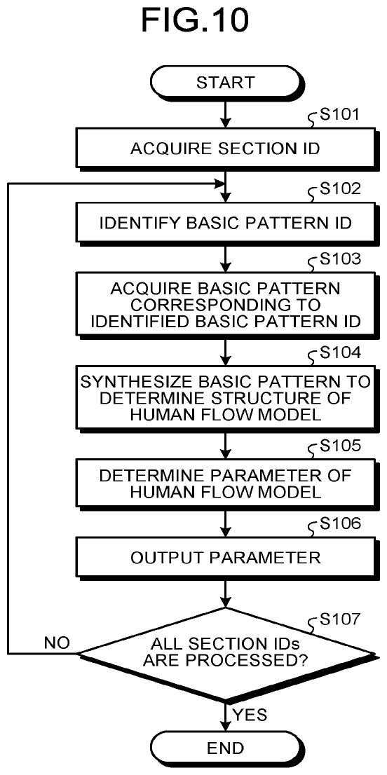

Next, a description will be given of the model generation processing by the information processing apparatus 100 according to the first embodiment. FIG. 10 is a flowchart illustrating an example of the model generation processing in the first embodiment.

Through the input device, for example, the user designates one or more sections in which the human flow model is to be generated. The acquisition unit 101 acquires section IDs of the designated sections (Step S101). Subsequently, the human flow models are constructed one by one for each of the designated section IDs.

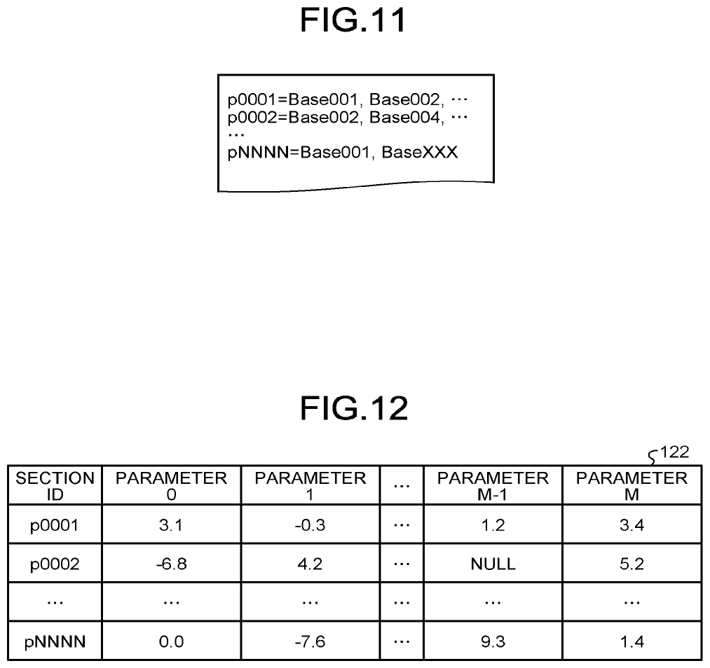

The model generation unit 102 acquires unprocessed section IDs, and identifies, for each of the acquired section IDs, one or more basic patterns determined as synthesis targets (Step S102). At this time, the model generation unit 102 may identify all basic patterns as synthesis targets, or may identify basic patterns determined for each of the section IDs. In the latter case, the model generation unit 102 may refer to the basic pattern setting file as illustrated in FIG. 11 for identifying the basic patterns for the section IDs.

FIG. 11 is a view illustrating an example of a data structure of the basic pattern setting file. The basic pattern setting file is described such that the section IDs and the basic pattern IDs of the basic patterns determined for the section IDs are associated with each other for each of rows.

Returning to FIG. 10, from the human flow pattern DB 130 (human flow table 132), the model generation unit 102 acquires the basic patterns corresponding to the identified basic pattern IDs (Step S103). The model generation unit 102 synthesizes the acquired basic patterns and determines a structure of the human flow model (Step S104).

An example of a method for synthesizing the human flow model will be described below. A structure of a human flow model to be synthesized for an i-th (i is an integer of 1 or more and N or less) section ID is defined as Gᵢ(t). Human flow data at a t-th time slot (t is an integer of 1 or more and T or less) in the i-th section ID is defined as \hat{ }y^{(i,t)}. Note that “\hat{ }y” is a variable in which a circumflex “\hat{ }” is assigned onto y, and means a predicted value of y. The readout basic pattern is defined as Fⱼ(t) (j is an integer of 1 or ore and M or less). The parameters are defined as {α⁽ⁱ⁾₀, α⁽ⁱ⁾₁, . . . , α⁽ⁱ⁾_{M}} The model generation unit 102 synthesizes (generates) the human flow model by, for example, the following Expression (1).

ŷ^{(i,t)}=Gᵢ(t)=α⁽ⁱ⁾₀+α⁽ⁱ⁾₁F₁(t)+ . . . +α⁽ⁱ⁾_{M}F_{M}(t) (1)

In Expression (1), α⁽ⁱ⁾₀ is a constant term. The function Fⱼ(t) indicating the basic pattern in Expression (1) is a function to extract, for example, a predicted value of human flow data in a given time slot t from the human flow table 132 while taking, as keys, a j-th basic pattern ID and a j-th time slot. The function Fⱼ(t) is not limited to this example.

Moreover, in Expression (1), the function Gᵢ(t) represents an expression for synthesizing the basic patterns by linear combination; however, is not limited to this example. Any method using a function, a model, or the like, which is capable of synthesizing one or more basic patterns may be used. For example, such a method may use a common statistical model and a machine learning model, such as a general linear model, a neural network model, and a deep learning model. In this case, each of the models is configured to, for example, receive one or more basic patterns and output a single human flow model.

After the structure of the human flow model is determined, the determination unit 103 determines the parameters {α⁽ⁱ⁾₀, α⁽ⁱ⁾₁, . . . , α⁽ⁱ⁾_{M}} of the synthesized human flow model Gᵢ(t) by using the human flow data stored in the past data 121 (Step S105).

For example, the determination unit 103 can determine the parameters {α⁽ⁱ⁾₀, α⁽ⁱ⁾₁, . . . , α⁽ⁱ⁾_{M}} of the human flow model of the i-th section ID by, for example, a least squares method like Expression (2). y^{(i,τ)} (τ is an integer of 1 or more and T or less) represents an actual value of the human flow data included in the past data 121.

$${argmin}_{\{ {α}_{0}^{( i )} , {α}_{1}^{( i )} , … , {α}_{M}^{( i )} \}} {\sum }_{τ = 1}^{T} {( {y}^{( i , τ )} - {G}_{i} ( τ ) )}^{2} \qquad ( 2 )$$

Note that a method for obtaining the parameters is not limited to the least squares method. Another method for obtaining such parameters that further reduce the error with respect to the past data 121 may be applied. For example, a method of maximum likelihood estimation, a Bayesian estimation method, or a quasi-Newton method may be used for the determination unit 103 to determine the parameters.

In the case of synthesizing the human flow model Gᵢ(t) by a machine learning model such as the neural network model, the determination unit 103 learns the machine learning model so as to minimize a loss function by, for example, using the past data 121 as training data, thereby determining parameters of the model.

Expression (2) of an evaluation function for optimizing the parameters may be modified to use sparse modeling. Expression (3) is an example of such a modification.

$${argmin}_{\{ {α}_{0}^{( i )} , {α}_{1}^{( i )} , … , {α}_{M}^{( i )} \}} \frac{1}{2} {\sum }_{τ = 1}^{T} {( {y}^{( i , τ )} - {G}_{i} ( τ ) )}^{2} + \frac{λ}{2} {\sum }_{m = 0}^{M} \vert {α}_{m}^{( i )} \vert \qquad ( 3 )$$

Expression (3) corresponds to an expression in which a penalty term as a second term of an argument of an argmin function is incorporated. The penalty term in Expression (3) is a term according to LASSO. The penalty term may be another penalty term such as Elastic Net. Moreover, Expression (3) may be configured to incorporate multiple penalty terms. Use of such a modified expression makes it possible to identify parameters that establish α⁽ⁱ⁾ₘ=0. That is, a configuration can be adopted so as not to select basic patterns in which the parameters turn to 0. In other words, it is made possible to make a selection that a part of the basic patterns is not to be used in the human flow model. Note that a hyperparameter λ in Expression (3) may be set in advance, or may be determined by an identification method of λ in general sparse modeling.

The determination unit 103 outputs the determined parameters and the determined structure of the human flow model to the parameter file 122 (Step S106). FIG. 12 is a view illustrating an example of a data structure of the parameter file 122.

As illustrated in FIG. 12, the parameter file 122 stores values of (M+1) pieces of parameters (parameter 0 to parameter M) for each of the section IDs. Note that the parameter 0 to the parameter M correspond to the above-described parameters {α⁽ⁱ⁾₀, α⁽ⁱ⁾₁, . . . , α⁽ⁱ⁾_{M}}.

In the case of a section in which a human flow model composed of not all the basic patterns but a part of selected basic patterns is used, “NULL” is set as a value of each parameter corresponding to the unselected basic pattern.

The parameters {α⁽ⁱ⁾₀, α⁽ⁱ⁾₁, . . . , α⁽ⁱ⁾_{M}} of the human flow model may have different values for each time slot t. In this case, for example, when the number of time slots is T, (M+1)×T pieces of the parameters are output to the parameter file 122.

Returning to FIG. 10, the model generation unit 102 determines whether or not all the section IDs are processed (Step S107). When all the section IDs are not processed yet (Step S107: No), the processing returns to Step S102, and is repeated for the next unprocessed section ID. When all the section IDs are processed (Step S107: Yes), the model generation processing is ended.

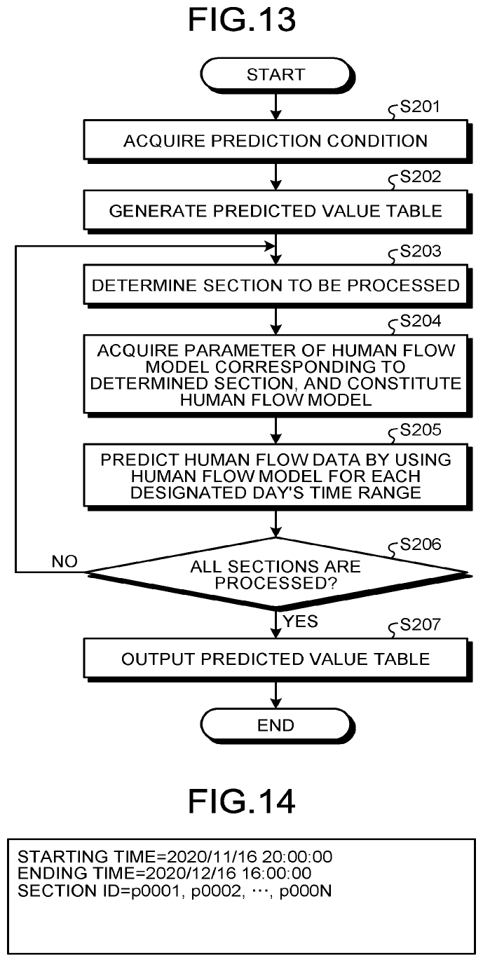

Next, the prediction processing by the information processing apparatus 100 according to the first embodiment will be described. The prediction processing is processing for obtaining predicted values of human flows of one or more sections by using the human flow model obtained by the model generation processing. FIG. 13 is a flowchart illustrating an example of the prediction processing in the first embodiment.

The user designates, through the input device, a time period and sections in which the human flows are to be predicted. The acquisition unit 101 acquires prediction conditions representing the designated period and sections (Step S201).

FIG. 14 is a view illustrating an example of the prediction conditions. The time period during which the human flows are to be predicted is designated by, for example, a starting time and an ending time. Each time is expressed in a format of “YYYY/MM/DD hh:mm:ss”. A method for designating the period is not limited to this, and may be any method. Moreover, for example, a time resolution in the period may be set like “time resolution=1 h”. When the time resolution is not set, the time resolution accords, for example, to a time resolution of human flow data stored in the past data 121. The sections in which the human flows are to be predicted are set in a format of the section IDs.

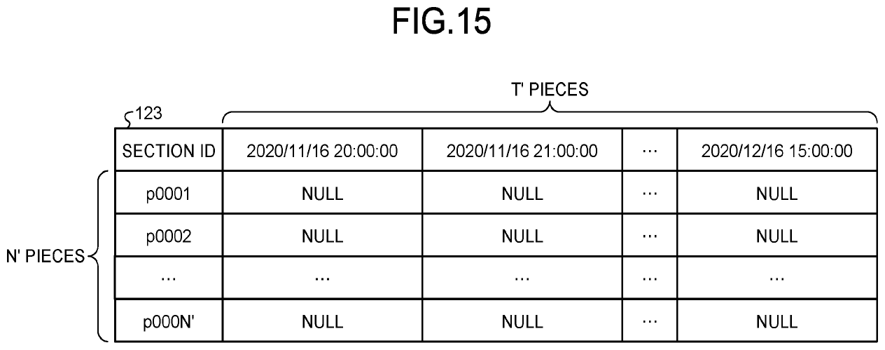

Returning to FIG. 13, the prediction unit 104 generates the predicted value table 123 in accordance with the acquired prediction conditions (Step S202). FIG. 15 is a view illustrating an example of a data structure of the predicted value table 123.

As illustrated in FIG. 15, the predicted value table 123 describes predicted values of human flow data for each of the section IDs and for each of the time slots. In FIG. 15, the predicted value table 123, in which predicted values in T′ pieces of time slot, are set for each of N′ pieces of section IDs. Note that N′ is determined on the basis of the sections in the prediction conditions, and T′ is determined on the basis of the starting time and the ending time in the prediction conditions.

The time slots are expressed in a format of “YYYY/MM/DD hh:mm:ss”. Between a starting point and an ending point based on the starting time and the ending time indicated by the prediction conditions, the time slots are set at intervals according to the time resolution. Therefore, each of the time slots has a range from a time expressed as a column name to one time before a time designated in a next column name. For example, when the column name is “2020/11/16 20:00:00” and the time resolution is 1 hour, a time slot designated by this column name is “2020/11/16 20:00:00 to 2020/11/16 20:59:59”.

In response to subsequent prediction operations, predicted values of human flows in sections indicated by the row names in the time slots indicated by the column names are inserted into the respective elements of the predicted value table 123. The predicted values are not yet calculated at the time of this step, and thus NULL values are inserted into all the elements.

Returning to FIG. 13, subsequently, the human flows are predicted for each of the designated section IDs (Step S203 to Step S206).

The prediction unit 104 determines the sections (section IDs) to be processed (Step S203). The prediction unit 104 acquires, from the parameter file 122, the parameters corresponding to the determined section IDs, and constitutes the human flow model by using the acquired parameters and the basic pattern read out from the human flow pattern DB 130 (human flow table 132) (Step S204).

The prediction unit 104 predicts the human flow data in the respective time slots in the designated period by using the constituted human flow model (Step S205). A description will be given below of an example of the case of predicting the human flow data in a time slot t′ (t′ is an integer of 1 or more and T′ or less) for the i-th section.

First, the prediction unit 104 reads out the parameters {α⁽ⁱ⁾₀, α⁽ⁱ⁾₁, . . . , α⁽ⁱ⁾_{M}} of the human flow model Gᵢ(t) of the i-th section described in the parameter file 122. The prediction unit 104 reads out, from the human flow table, the basic pattern corresponding to the parameters in which values are not NULL among the parameters {α⁽ⁱ⁾₀, α⁽ⁱ⁾₁, . . . , α⁽ⁱ⁾_{M}}, and constitutes the human flow model Gᵢ(t). The prediction unit 104 calculates the predicted value of the human flow in the time slot t″ by the constituted human flow model Gᵢ(t). The prediction unit 104 causes storage of the calculated predicted value as an element in a row corresponding to the relevant section ID in the predicted value table 123 and in a column corresponding to the time slot t′.

The prediction unit 104 determines whether or not all the sections are processed (Step S206). When all the sections are not processed yet (Step S206: No), the processing returns to Step S203, and is repeated for the next section.

When all the sections are processed (Step S206: Yes), the prediction unit 104 outputs the predicted value table 123 (Step S207), and ends the prediction processing.

As described above, in the first embodiment, basic patterns determined for each of the sections out of multiple basic patterns are synthesized, whereby the prediction model (human flow model) is generated, and the prediction is executed by using the generated model. Thus, the accuracy of the prediction of the data (for example, the human flow), the prediction using a model, can be improved.

### Second Embodiment

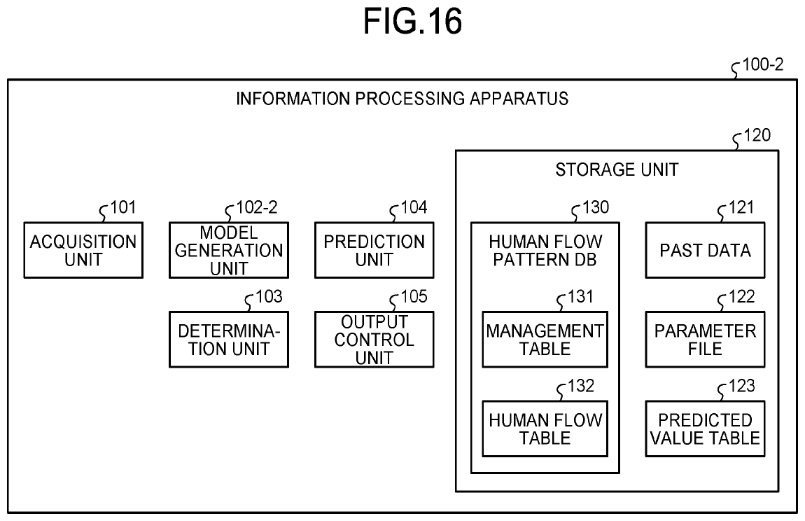

In a second embodiment, a description will be given of an example of using a basic pattern different from that of the first embodiment. FIG. 16 is a block diagram illustrating an example of a configuration of an information processing apparatus 100-2 according to the second embodiment. As illustrated in FIG. 16, the information processing apparatus 100-2 includes an acquisition unit 101, a model generation unit 102-2, a determination unit 103, a prediction unit 104, an output control unit 105, and a storage unit 120.

The second embodiment is different from the first embodiment in terms of a function of the model generation unit 102-2. The other configurations and functions are similar to those in FIG. 1 that is the block diagram of the information processing apparatus 100 according to the first embodiment. Thus, the same reference numerals are assigned thereto, and a description thereof is omitted herein.

The model generation unit 102-2 generates a human flow model by synthesizing basic patterns different from those in the first embodiment.

Note that the entire flow of the model generation processing and the prediction processing in the second embodiment is similar to that in FIGS. 10 and 13 in the first embodiment, and accordingly, a description thereof will be omitted. A description will be given below of examples of the basic patterns for use in the present embodiment.

A function Fⱼ(t) representing each of the basic patterns can be represented by a mathematical model that has U pieces (U is an integer of 1 or more) of parameters {pᵢ, p₂, . . . , p_{U}}. The mathematical model can be models with such a variety of forms as follows. At least part of the M pieces of basic patterns may be represented by mathematical models different from one another.
Basic functions: a quadratic function, a sin function, and a cos function
General machine learning models: a neural network model and a deep learning model
Statistical models: mean value, median, maximum value, minimum value, first quartile, third quartile, regression model, multiple regression model, general additive model, and general linear model
State space model
Auto regression model

For example, as shown in Expression (4), the j-th basic pattern can be expressed by a mathematical model of a sin function regarding the time slot t.

$${F}_{j} ( t ) = sin ( \frac{t}{24} * π + {p}_{1}^{( i )} ) \qquad ( 4 )$$

The mathematical model of the sin function in Expression (4) can store formats of the functions, that is, model structures as the basic patterns, and can have values of the parameters p⁽ⁱ⁾₁ different for each of the section IDs. Therefore, in a human flow pattern DB 130 of the present embodiment, the basic pattern IDs are managed by a management table 131, and objects that indicate the formats of the functions for each of the basic patterns are managed as the model structures by a human flow table 132.

The values of the parameters p⁽ⁱ⁾₁, which indicate phases in Expression (4), may be determined simultaneously when the determination unit 103 determines the parameters {α⁽ⁱ⁾₀, α⁽ⁱ⁾₁, . . . , α⁽ⁱ⁾_{M}} by using Expression (2). Values of the parameters p⁽ⁱ⁾₁ may be set in advance.

The basic patterns may be represented by using actual values of past human flow data and human flow data in other sections. That is, the basic patterns may include patterns that change in response to human flow data measured in the past in at least one of the subject section and sections other than the subject section. For example, the following Expression (5) is an example of an expression that represents a basic pattern using a vector auto regression model. Expression (5) has a format that uses actual values of the past human flows in the subject section until a time slot Q pieces before.

Fⱼ(t)=Σ_{q=1}^{Q}p_{q}⁽ⁱ⁾*y_{t-q}⁽ⁱ⁾+p₀⁽ⁱ⁾ (5)

Expression (6) is another example of an expression that represents a basic pattern using the vector auto regression model. Expression (6) is an example of an expression that uses, as a variable, an actual value of the past human flow in the h-th (h is an integer of 1 or more and N or less, satisfying i≠h) other section.

$${F}_{j} ( t ) = \{ \begin{matrix}{\hat{y}}^{( i )} = {\sum }_{q = 1}^{Q} {p}_{q}^{( i )} * {y}_{t - q}^{( i )} + {\sum }_{k = 1}^{K} {p}_{k}^{( i )} * {y}_{t - k}^{( h )} + {p}_{0}^{( i )} \\ {\hat{y}}^{( h )} = {\sum }_{r = 1}^{R} {p}_{r}^{( i )} * {y}_{t - r}^{( h )} + {\sum }_{s = 1}^{S} {p}_{s}^{( i )} * {y}_{t - s}^{( i )} + {p}_{0}^{( h )}\end{matrix} \qquad ( 6 )$$

For predicting the human flow data, there may be used information, such as weather information or mobility information, which has been stored in other devices (a database device, a storage apparatus, and the like). The weather information includes an air temperature, a humidity, a precipitation, a snowfall, a solar radiation intensity, a total amount of sunshine, and the like in each section. The mobility information includes a traffic, the number of routs, the number of stations, and the like in each section. A description will be given below of an example of using the weather information.

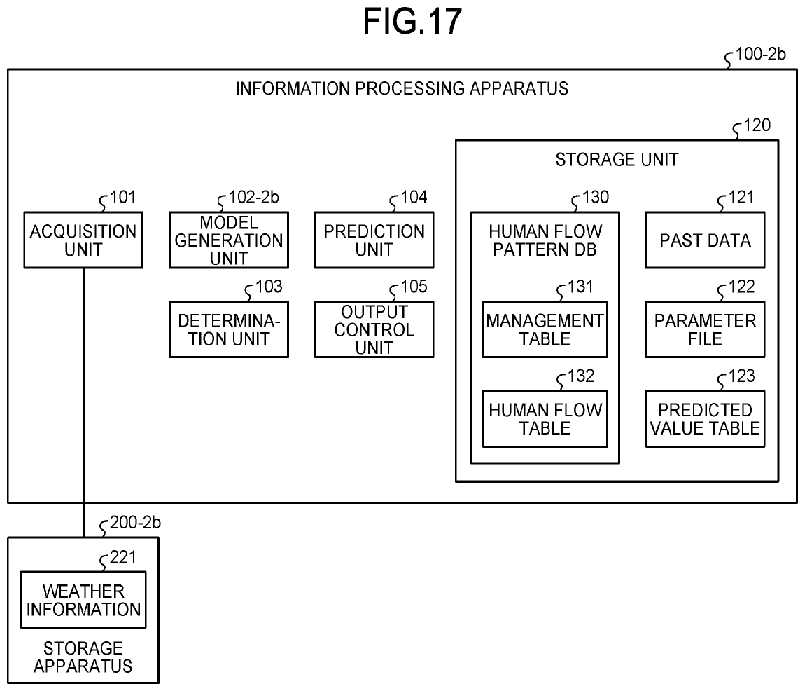

FIG. 17 is a block diagram illustrating an example of a configuration of an information processing apparatus 100-2b according to a modified example of the second embodiment. As illustrated in FIG. 17, the information processing apparatus 100-2b includes an acquisition unit 101, a model generation unit 102-2b, a determination unit 103, a prediction unit 104, an output control unit 105, and a storage unit 120.

Moreover, the information processing apparatus 100-2b is connected to a storage apparatus 200-2b. The information processing apparatus 100-2b and the storage apparatus 200-2b may be connected to each other in any form; however, for example, can be connected to each other by a network such as the Internet. The network may be either a wired network or a wireless network, or may have a form in which both thereof are mixed with each other.

The storage apparatus 200-2b stores weather information 221. The weather information 221 includes, for example, an air temperature table that stores temperatures for each of the time slots and each of the sections, and a precipitation table that stores precipitations for each of the time slots and each of the sections. A description will be given below of an example of using the air temperature and the precipitation as the weather information.

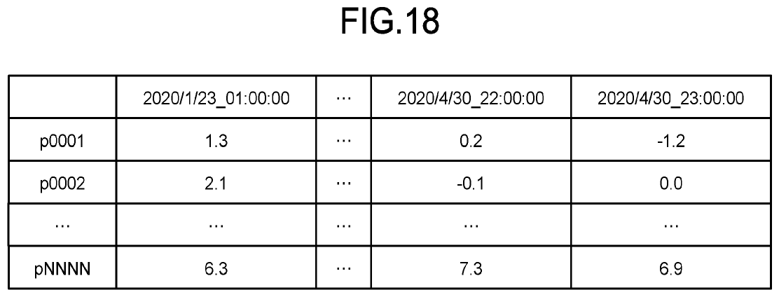

FIG. 18 is a view illustrating an example of a data structure of the air temperature table. Note that the precipitation table can also adopt a similar structure to that of the air temperature table. As illustrated in FIG. 18, the air temperature table values of air temperatures for each of the section IDs and each piece of date and time.

Expression (7) is an example of an expression representing a basic pattern that uses an air temperature x⁽ⁱ⁾₁ and a precipitation x⁽ⁱ⁾₂.

Fⱼ(t)=p₁⁽ⁱ⁾*x_{1,t}⁽ⁱ⁾+p₂⁽ⁱ⁾*x_{2,t}⁽ⁱ⁾+p₀⁽ⁱ⁾ (7)

Parameters {p⁽ⁱ⁾₁, p⁽ⁱ⁾₂, p⁽ⁱ⁾₀} in Expression (7) are adjusted by, for example, the determination unit 103 in accordance with the actual values of the air temperatures and the precipitations in the past and with the predicted values thereof.

The weather information 221 may be referred to by the prediction unit 104 when predicting the human flow data. For example, the prediction unit 104 reads out the weather information corresponding to the time slot and the section, each being targets of predicting the human flow data, from the storage apparatus 200-2b, and uses the readout weather information for the prediction processing.

As described above, in the information processing apparatus according to the second embodiment, the model generation processing and the prediction processing can be executed by using the basic patterns represented in the variety of formats.

### Third Embodiment

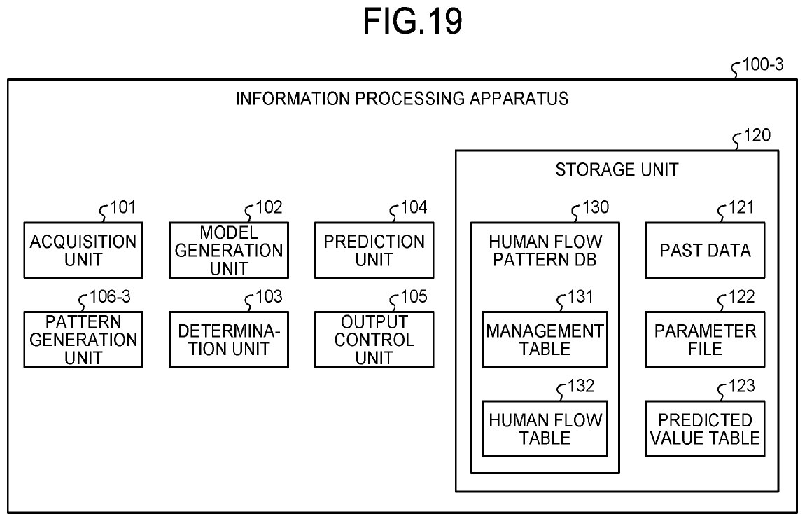

An information processing apparatus according to a third embodiment has a function to generate basic patterns. FIG. 19 is a block diagram illustrating an example of a configuration of an information processing apparatus 100-3 according to the third embodiment. As illustrated in FIG. 19, the information processing apparatus 100-3 includes an acquisition unit 101, a model generation unit 102, a determination unit 103, a prediction unit 104, an output control unit 105, a pattern generation unit 106-3, and a storage unit 120.

The third embodiment is different from the first embodiment in that the pattern generation unit 106-3 is added. Other configurations and functions are similar to those in FIG. 1 that is the block diagram of the information processing apparatus 100 according to the first embodiment, and accordingly, the same reference numerals are assigned thereto, and a description thereof is omitted herein. Note that, while FIG. 19 is an example of a configuration of adding the pattern generation unit 106-3 to the first embodiment, a configuration may also be adopted such that the pattern generation unit 106-3 is added to the second embodiment.

The pattern generation unit 106-3 generates basic patterns for use in synthesizing a human flow model. For example, the pattern generation unit 106-3 generates one or more basic patterns by clustering actual values of human flow data measured in the past, and outputs the basic patterns to a management table 131 and a human flow table 132. More specifically, the pattern generation unit 106-3 classifies the actual values of the human flow data into multiple clusters on the basis of similarities between pieces of the human flow data, and generates multiple basic patterns corresponding to a different one of the multiple clusters by using data belonging to a corresponding one of the multiple clusters having been classified.

Note that the model generation unit 102 synthesizes the basic patterns generated as described above, thereby generating the human flow model. The entire flow of the model generation processing and the prediction processing in the third embodiment is similar to that in FIGS. 10 and 13 in the first embodiment, and accordingly, a description thereof will be omitted.

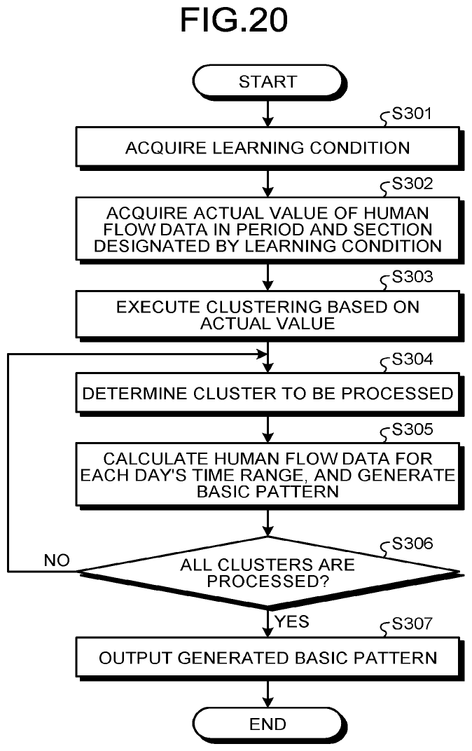

Next, a description will be given of the pattern generation processing by the information processing apparatus 100-3 according to the third embodiment with reference to FIG. 20. FIG. 20 is a flowchart illustrating an example of the pattern generation processing in the third embodiment.

The user designates learning conditions through the input device. The learning conditions include ranges of the periods and the sections of the past human flow data used for generating the basic patterns. Each period is represented by, for example, a starting time and an ending time. Each time is expressed in a format of “YYYY/MM/DD hh:mm:ss”. Moreover, the range of the sections is designated, for example, by one or more section IDs.

The acquisition unit 101 acquires the designated learning conditions (Step S301). The pattern generation unit 106-3 acquires, from the past data 121, the actual values of the past human flow data in the periods designated by the learning conditions and the sections identified by the section IDs (Step S302).

The pattern generation unit 106-3 executes the clustering that is based on the actual values (Step S303). First, the pattern generation unit 106-3 calculates similarities between the section IDs from the acquired actual values, and generates a similarity table.

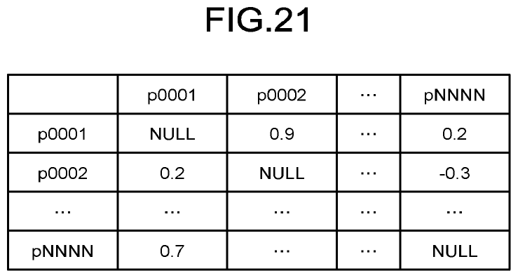

FIG. 21 is a view illustrating an example of a data structure of the similarity table. As illustrated in FIG. 21, in the similarity table, the section IDs are set in both of column names and row names, and in elements, there are stored the similarities of the actual values between the section IDs of the column names and the section IDs of the row names. NULL is set as each of the elements between the same section IDs.

A method for calculating the similarities may be any method of calculating a similarity between two series data. For example, the similarity may be a correlation coefficient and a cosine similarity. The similarity may be dynamic time warping and an inverse number of a distance such as a Euclidean distance.

Next, the pattern generation unit 106-3 executes the clustering on the basis of the calculated similarity. For example, the pattern generation unit 106-3 classifies, into one cluster, the section IDs in which similarities are preset threshold value or more.

The pattern generation unit 106-3 generates one basic pattern for one cluster. That is, the pattern generation unit 106-3 generates basic patterns whose quantity is equivalent to the number of the clusters. Returning to FIG. 20, a description will be given below of an example of a method for generating the basic patterns for each of the clusters.

The pattern generation unit 106-3 determines a cluster to be processed from among one or more clusters obtained by the clustering (Step S304). For each of the time slots, the pattern generation unit 106-3 calculates the human flow data by an average value of the past actual values in the section IDs belonging to the determined cluster, thereby generating the basic pattern (Step S305).

The pattern generation unit 106-3 determines whether or not all the clusters are processed (Step S306). When all the clusters are not processed (Step S306: No), the processing returns to Step S304, and is repeated for the next cluster. When all the clusters are processed (Step S306: Yes), the pattern generation unit 106-3 outputs the generated basic pattern, for example, as the human flow table 132 (Step S307), and ends the pattern generation processing.

As described above, in the third embodiment, the basic pattern can be generated by using the actual values of the past human flow data, and can be used for the model generation processing and the prediction processing.

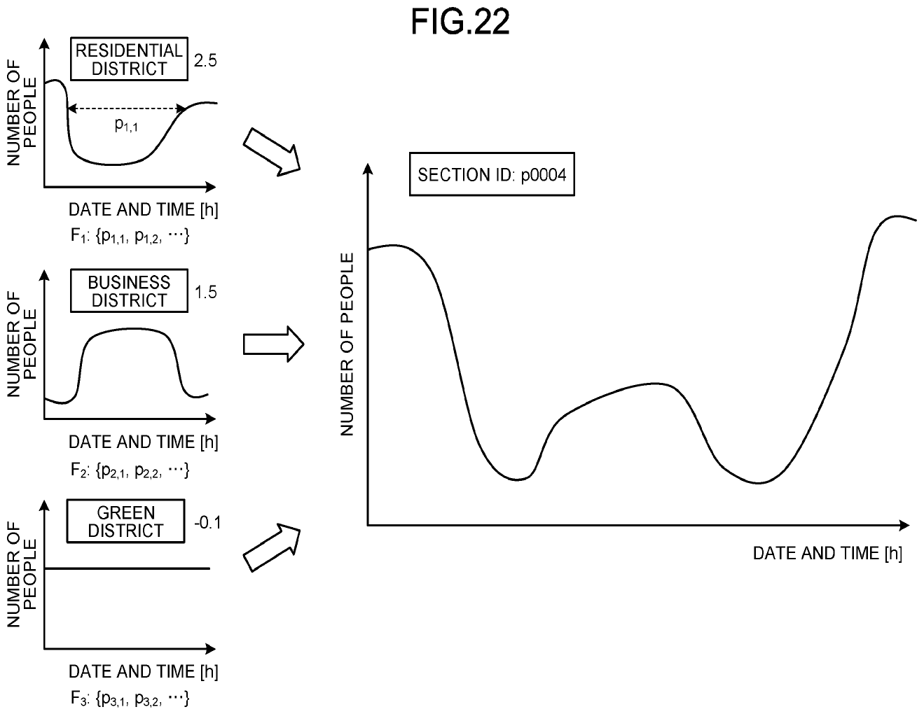

A description will be given below of an example of a display screen applicable to each of the above-described embodiments. FIG. 22 is a view illustrating an example of a display screen illustrating a relationship between a human flow model generated for a given section and basic patterns for use in this generation.

In FIG. 22, an example is illustrated for a display screen that displays parameters {α⁽ⁱ⁾₀, α⁽ⁱ⁾₁, . . . , α⁽ⁱ⁾_{M}} of the human flow model, that is, synthetic ratios of the basic patterns generated for a given section whose section ID is “p0004”. For example, the parameters (synthetic ratios) of the basic patterns corresponding to the residential district, the business district, and the green district are 2.5, 1.5, and −0.1, respectively. By showing such information to the user, the user becomes able to easily understand a key factor that constitutes the human flow.

Note that p_{j,u} in FIG. 22 means a u-th (u is an integer of 1 or more and U or less) parameter of the function Fⱼ(t) represented, for example, by Expressions (4) to (6) of the second embodiment.

As described above, in accordance with the first to third embodiments, it becomes possible to execute the prediction of the data, which uses the models, with higher accuracy.

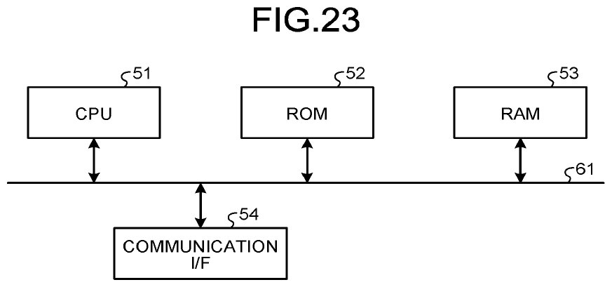

Next, referring to FIG. 23, a description will be given of a hardware configuration of the information processing apparatus according to the first to third embodiments. FIG. 23 is an explanatory view illustrating a hardware configuration example of the information processing apparatus according to the first to third embodiments.

The information processing apparatus according to the first to third embodiments includes a control device such as a CPU 51, storage apparatuses such as a read only memory (ROM) 52 and a RAM 53, a communication I/F 54 for connecting to a network and performing communication, and a bus 61 for connecting the respective units to one another.

A computer program executed by the information processing apparatus according to the first to third embodiments is provided while being embedded in advance in the ROM 52 and the like.

The program executed by the information processing apparatus according to the first to third embodiments may be configured to be a file in an installable format or an executable format, and to be provided as a computer program product by being recorded on a computer-readable recording medium such as a compact disk read only memory (CD-ROM), a flexible disk (FD), a compact disk recordable (CD-R), or a digital versatile disk (DVD).

Moreover, the program executed by the information processing apparatus according to the first to third embodiments may be configured to be stored in a computer connected to a network such as the Internet, and to be provided by being downloaded over the network. Moreover, the program executed by the information processing apparatus according to the first to third embodiments may be configured to be provided or distributed over the network such as the Internet.

The program executed by the information processing apparatus according to the first to third embodiments can cause a computer to function as the above-mentioned respective units of the information processing apparatus. This computer can cause the CPU 51 to read out the program from the computer-readable storage medium onto the main storage apparatus, and to execute the same.

While given embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
one or more hardware processors configured to function as
an acquisition unit serving to acquire one or more patterns from among multiple patterns each representing temporal variation of first data being data to be predicted, the patterns being determined for a first region designated out of regions serving as prediction targets of the first data;
a model generation unit serving to generate a prediction model for predicting the temporal variation of the first data in the first region, the prediction model being generated on the basis of the acquired patterns; and
a determination unit serving to determine a parameter of the prediction model.

2. The information processing apparatus according to claim 1, wherein the model generation unit generates the prediction model by synthesizing the acquired patterns.

3. The information processing apparatus according to claim 2, wherein the model generation unit serves to generate the prediction model by performing line combination on the acquired patterns.

4. The information processing apparatus according to claim 1, wherein the model generation unit serves to generate the prediction model by using a machine learning model to which the acquired patterns are input and from which the prediction model is output.

5. The information processing apparatus according to claim 1, wherein the determination unit serves to determine the parameter such that an error between measurement data being the measured first data and the first data predicted by the prediction model becomes smaller.

6. The information processing apparatus according to claim 1, wherein the hardware processors are configured to function as a pattern generation unit serving to
classify pieces of measurement data, each being the measured first data, into multiple clusters on the basis of similarities between the pieces of measurement data, and
generate multiple patterns individually corresponding to a different one of the multiple clusters, each of the multiple patterns being generated by using one of the pieces of the measurement data belonging to a corresponding one of the multiple clusters.

7. The information processing apparatus according to claim 1, wherein the multiple patterns include a pattern that changes in response to measurement data being the first data measured in the past in the first region.

8. The information processing apparatus according to claim 1, wherein the multiple patterns include a pattern that changes in response to measurement data being the first data measured in the past in a region other than the first region.

9. The information processing apparatus according to claim 1, wherein the multiple patterns are each represented by a machine learning model.

10. The information processing apparatus according to claim 1, wherein the first data is data representing a population in the region.

11. The information processing apparatus according to claim 1, wherein the regions include at least one of a residential district, a business district, a commercial use district, an industrial district, and a green district.

12. An information processing apparatus comprising:
one or more hardware processors coupled to a memory and configured to
acquire one or more patterns from among multiple patterns each representing temporal variation of first data being data to be predicted, the patterns being determined for a first region designated out of regions serving as prediction targets of the first data;
generate a prediction model for predicting the temporal variation of the first data in the first region, the prediction model being generated on the basis of the acquired patterns; and
determine a parameter of the prediction model.

13. An information processing method implemented by a computer as an information processing apparatus, the method comprising:
acquiring one or more patterns from among multiple patterns each representing temporal variation of first data being data to be predicted, the patterns being determined for a first region designated out of regions serving as prediction targets of the first data;
generating a prediction model for predicting the temporal variation of the first data in the first region, the prediction model being generated on the basis of the acquired patterns; and
determining a parameter of the prediction model.

14. A computer program product comprising a non-transitory computer-readable recording medium on which an executable program is recorded, the program instructing a computer to:
acquire one or more patterns from among multiple patterns each representing temporal variation of first data being data to be predicted, the patterns being determined for a first region designated out of regions serving as prediction targets of the first data;
generate a prediction model for predicting the temporal variation of the first data in the first region, the prediction model being generated on the basis of the acquired patterns; and
determine a parameter of the prediction model.
